(19) United States
(12) Patent Application Publication
(10) Pub. No.: US 2007/0126626 A1
(43) Pub. Date: Jun. 7, 2007

(54) SYSTEM FOR POSITIONING MOBILE COMMUNICATION APPARATUS AND METHOD THEREOF

(76) Inventors: Shao-Tsu Kung, Taipei City (TW); Ko-Chien Chuang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,814

(22) Filed: Feb. 24, 2006

(30) Foreign Application Priority Data
Dec. 5, 2005 (TW) 94142748

(51) Int. Cl. G01S 5/14; H04Q 7/20

(52) U.S. Cl. 342/357.09; 455/456.3

(57) ABSTRACT

A system for a mobile communication apparatus for positioning the mobile communication apparatus is provided. The mobile communication apparatus comprises a controller, a signal transmitter/receiver, a positioning receiver, and a display. Wherein, the positioning receiver receives a positioning signal transmitted by a Global Positioning System (GPS). The signal transmitter/receiver coupled to the positioning receiver is configured to transmit the positioning signal to an external device. The signal transmitter/receiver also receives the positioning related information determined according to the positioning signal from the external device. The controller respectively couples to the signal transmitter/receiver, the positioning receiver, and the display. Moreover, the display is adopted for displaying the positioning related information.

### CROSS-REFERENCE TO RELATED APPLICATION

This application claims the priority benefit of Taiwan application serial no. 94142748, filed on Dec. 5, 2005. All disclosure of the Taiwan application is incorporated herein by reference.

### BACKGROUND OF THE INVENTION

1. Field of the Invention

The present invention relates to a Global Positioning System (GPS), and more particularly, to a system for positioning a mobile communication apparatus.

2. Description of the Related Art

The Global Positioning System (GPS) is a device commonly used in the satellite navigation system in the vehicle or embedded in the Personal Digital Assistants (PDA). Since the GPS requires receiving the positioning signals from the positioning satellites for comparing it with the related map data, a high resolution satellite positioning and a high density memory are usually required by the electronic apparatus where the GPS is embedded to preload the map data and to provide the high speed multimedia computing capability. In the conventional method for positioning the mobile communication apparatus, a great amount of map data is stored in the mobile communication apparatus, and the positioning signals are compared with the map data. Such positioning method not only consumes the computing resources, but also increases the workload and power consumption of the mobile communication apparatus, which significantly impacts the available usage time of the mobile communication apparatus. In addition, the requirement of high density memory and computing system would make the mobile communication apparatus more sophisticated and comples, and thereby increase the overall cost of the mobile communication apparatus. Moreover, the operation of such system is rather complicated requiring several operation steps for obtaining the desired positioning data. For those who are not familiar with the electronic apparatus interface or the software user interface, such method causes great inconvenience to the users. For example, such operation of searching addresses or positioning is rather difficult for children or seniors.

### SUMMARY OF THE INVENTION

Therefore, it is an object of the present invention to provide a system for positioning a mobile communication apparatus, wherein the positioning process system is adopted for computing the received positioning signal to obtain the desired positioning related information. Thus, the mobile communication apparatus need not compare and compute the positioning signals or store great amount of map data. Therefore, the mobile communication apparatus of present invention is not only easy to operation but is also comparatively less expensive and consumes less power compared to the conventional the mobile communication apparatus.

In accordance with the object and other objects of the present invention, a system for positioning a mobile communication apparatus is provided. The system is integrated into the mobile communication apparatus. The mobile communication apparatus comprises a positioning receiver, a signal transmitter/receiver, a controller and a display. Wherein, the positioning system obtains the positioning related information from the high-frequency low-power positioning signals sent by the satellite. In addition, the positioning receiver receives the corresponding positioning signal sent by the GPS. The signal transmitter/receiver coupled to the positioning receiver is configured to transmit the positioning signal to a device external to the mobile communication apparatus and to receive the positioning related information that is determined according to the positioning signal transmitted from the same or other device external to the mobile communication apparatus.

One of the devices external to the mobile communication apparatus, or, in short, an external device, mentioned above comprises a positioning process system. The positioning process system compares the positioning signals and transmits the location related data that is obtained after the comparison to the mobile communication apparatus by using the short message, graphic picture, voice or text transmitting method. Wherein, the positioning related information includes the addresses. Further, the controller in the mobile communication apparatus controls the transmitting and receiving operations of the positioning receiver and the signal transmitter/receiver. The controller is adopted for transmitting and processing the received data. The controller further comprises a key pad. In response to a key operation, the signal transmitter/receiver is directly controlled to transmit the positioning signal to the external device and to receive the positioning related information corresponding to the positioning signal from the external device. The display is adopted for displaying the received positioning related information. Such one key operation interface significantly reduces the operation complexity, so that the positioning system is more user-friendly.

In an embodiment of the present invention, the signal transmitter/receiver of the mobile communication apparatus mentioned above uses the specific protocol of individual mobile communication apparatus to provide the functions of sending a “request for a second person's location” signal and receiving the positioning related information of the second person's mobile communication apparatus from the second person's mobile communication apparatus or the above mentioned external device. Here, the positioning related information is obtained from the computing process according to the positioning signal sent by the second person's mobile communication apparatus. This function is very helpful for children's safety and is also useful for tracking the current location of people such as seniors with memory impairment problems and the mentally challenged persons.

According to another aspect of the present invention, a method for positioning a mobile communication apparatus is provided. The positioning method comprises the following steps. First, the mobile communication apparatus receives a positioning signal. Then, the mobile communication apparatus transmits the received positioning signal to an external device for generating the positioning related information. Here, the positioning related information including the addresses is transmitted by a short message, voice or graphic picture transmitting method. Then, the mobile communication apparatus receives the positioning related information from the external device, and the received positioning related information is displayed on the display of the mobile communication apparatus.

In an embodiment of the present invention, the mobile communication apparatus issues a “request for a second person's location” signal to request for the positioning related information of the second person's mobile communication apparatus and then the mobile communication apparatus receives the positioning related information of the second person's mobile communication apparatus corresponding to the positioning signal sent by the second person's mobile communication apparatus.

Accordingly, the mobile communication apparatus, according to the present invention, the positioning process system is adopted for computing the received positioning signal to obtain the desired positioning related information. Thus, the mobile communication apparatus need not compare and compute the received positioning signals or store a great amount of map data. Therefore, the mobile communication apparatus of present invention is not only easy to operation but is also comparatively less expensive and consumes less power compared to the conventional the mobile communication apparatus. In addition, the functions of searching the positioning related information for other mobile communication apparatus and the one key operation significantly reduces the usage complexity. Accordingly, the positioning system provided by the present invention is very helpful for children's safety and is also useful for tracking the current location of people such as seniors with memory impairment problems and mentally challenged persons.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 schematically shows a block diagram of a system for positioning a mobile communication apparatus according to an embodiment of the present invention.

FIG. 2 schematically shows a flow chart illustrating a method for positioning a mobile communication apparatus according to an embodiment of the present invention.

FIG. 3 schematically shows a flow chart illustrating a method for positioning a second person's mobile communication apparatus according to an embodiment of the present invention.

### DESCRIPTION PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

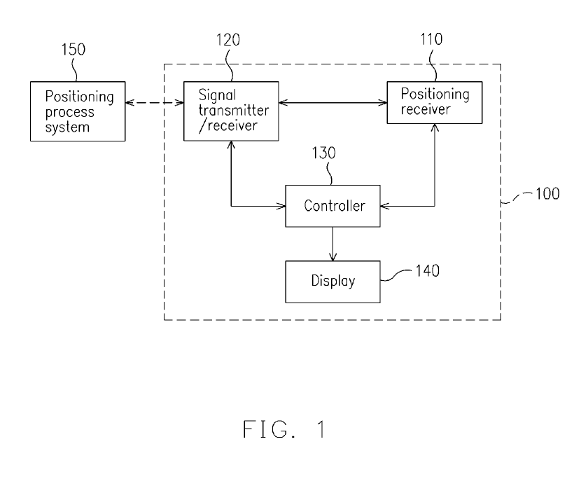

An embodiment of the present invention is described in detail with reference to FIG. 1 hereinafter. FIG. 1 schematically shows a block diagram of a system for positioning a mobile communication apparatus according to an embodiment of the present invention. The mobile communication apparatus 100 comprises a positioning receiver 110, a signal transmitter/receiver 120, a controller 130, and a display 140. Wherein, the controller 130 respectively couples to the signal transmitter/receiver 120, the positioning receiver 110 and the display 140. The signal transmitter/receiver 120 further couples to the positioning receiver 110. In addition, a positioning process system 150 is installed on a specific location of a base where it can communicate with the signal transmitter/receiver 120. After the mobile communication apparatus 100 receives the positioning signal sent by the GPS through the positioning receiver 110, the signal transmitter/receiver 120 transmits the positioning signal to the positioning process system 150. Here, the positioning process system 150 is a system installed outside of the mobile communication apparatus 100. The positioning process system is configured to store the related map data and compare/compute the positioning signals sent by the signal transmitter/receiver 120, and to generate the positioning related information corresponding to the positioning signal. Wherein, the positioning related information includes addresses, distinct landmarks or buildings, etc. In addition, the positioning related information is transmitted to the signal transmitter/receiver 120 by using a short message, graphic picture, voice or text transmitting method. After the signal transmitter/receiver 120 receives the positioning related information, the positioning related information is displayed by the display 140. Moreover, a controller 130 may be further installed in the mobile communication apparatus 100 for controlling the signal transmitter/receiver 120 to transmit the positioning signals and to receive the positioning related information. It should be noted that, the signals transmitted between the signal transmitter/receiver 120 and an external device including the positioning process system 150 may follow a different transmission path that is comprised of different transmitting components. Accordingly, an external device receiving the signal from the signal transmitter/receiver 120 may be not the external device transmitting the signal to the signal transmitter/receiver 120.

In the present embodiment of the present invention, the controller 130 may be controlled by a key. Specifically, in response to a key operation, the mobile communication apparatus 100 receives and transmits the positioning signals, and receives and displays the positioning related information of the mobile communication apparatus 100 from the positioning system 150. In other words, the user can obtain the positioning related information of the mobile communication apparatus 100 merely by using such one key operation without the additional operation steps as in the case of the conventional mobile communication apparatus. Moreover, if the user desires to obtain the positioning related information of a second person, the signal transmitter/receiver 120 can send out a “request for the second person's location” signal to request for the positioning related information of the second person's mobile communication apparatus 100 through the communication protocol used between different mobile communication apparatus 100. Then, the positioning process system 150 obtains the positioning signal of the second person's mobile communication apparatus 100 according to the request signal, and transmits the positioning related information corresponding to the second person's mobile communication apparatus 100 to the signal transmitter/receiver 120 of the user. Afterwards, the signal transmitter/receiver 120 receives the positioning related information of the second person's mobile communication apparatus 100, which is displayed on the display 140. The positioning related information mentioned above corresponds to the positioning signal sent by the second person's mobile communication apparatus.

For better understanding of one of the ordinary skill in the art, the following embodiments are described in detail with reference to FIG. 1 hereinafter.

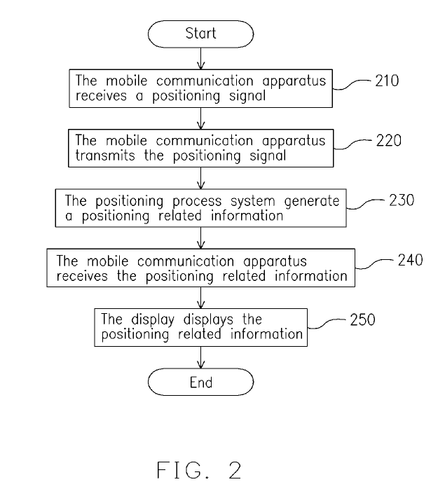

FIG. 2 schematically shows a flow chart illustrating a method for positioning a mobile communication apparatus according to an embodiment of the present invention. The positioning method comprises the following steps. First, in step 210, the mobile communication apparatus 100 receives a positioning signal from the positioning receiver 110. Next, in step 220, the mobile communication apparatus 100 transmits the received positioning signal to the positioning process system 150 though the signal transmitter/receiver 120. In step 230, the positioning process system 150 compares/computes the corresponding positioning related information according to the positioning signal sent by the mobile communication apparatus 100, and transmits the positioning related information to the mobile communication apparatus 100 by using one of the short message, voice, graphic picture, and text transmitting methods. The positioning related information mentioned above includes addresses. Next, in step 240, the mobile communication apparatus 100 uses the signal transmitter/receiver 120 to receive the positioning related information sent by the positioning process system 150 in step 230. Finally, in step 250, the display 140 displays the positioning related information received by the signal transmitter/receiver 120.

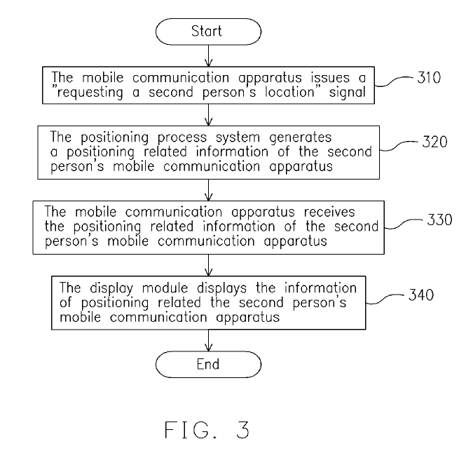

FIG. 3 schematically shows a flow chart illustrating a method for positioning a second person's mobile communication apparatus according to an embodiment of the present invention. The positioning method comprises the following steps. First, in step 310, the mobile communication apparatus 100 uses the signal transmitter/receiver 120 to issue a “request for the second person's location” signal to request for the positioning related information of the second person's mobile communication apparatus 100. Next, in step 320, the positioning process system 150 generates the positioning related information of the second person's mobile communication apparatus according to the positioning signal of the second person's mobile communication apparatus, and transmits the positioning related information by using one of the short message, voice, graphic picture, and text transmitting methods. Wherein, the positioning related information corresponds to the positioning signal sent by the second person's mobile communication apparatus. Finally, in step 340, the received positioning related information of the second person's mobile communication apparatus is displayed by the display 140.

In summary, the mobile communication apparatus of the present invention is not only easy to operate, but is also less expensive and consumes less power compared to the conventional mobile communication apparatus as storage of a great amount of map data or computation device are not required. Moreover, the functions of searching the positioning related information for other mobile communication apparatus and the one key operation significantly reduces the usage complexity. Accordingly, the positioning system provided by the present invention is very helpful for children's safety and is also useful for tracking the real-time location of people such as seniors with memory impairment problems and the mentally challenged persons.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A system for a mobile communication apparatus for positioning the mobile communication apparatus, comprising:
a positioning receiver, for receiving a corresponding positioning signal sent by a Global Positioning System (GPS); and
a signal transmitter/receiver, coupled to the positioning receiver, for transmitting the corresponding positioning signal externally to the mobile communication apparatus and for receiving a positioning related information determined according to the corresponding positioning signal externally from the mobile communication apparatus.

2. The system for a mobile communication apparatus for positioning the mobile communication apparatus of claim 1, further comprising a controller for controlling transmission/receiving operations of the signal transmitter/receiver.

3. The system for a mobile communication apparatus for positioning the mobile communication apparatus of claim 1, further comprising a display for displaying the corresponding positioning related information.

4. The system for a mobile communication apparatus for positioning the mobile communication apparatus of claim 1, wherein the signal transmitter/receiver further comprises a function of issuing a “request for a second person's location signal” and receiving positioning related information determined according to a positioning signal of the mobile communication apparatus corresponding to the “request for the second person's location signal” externally from the mobile communication apparatus.

5. The system for a mobile communication apparatus for positioning the mobile communication apparatus of claim 4, wherein the positioning related information comprises addresses.

6. A method for positioning a mobile communication apparatus, comprising:
using a mobile communication apparatus to receive a positioning signal;
transmitting the positioning signal to an external device for generating a positioning related information; and
receiving the positioning related information from the external device.

7. The method for positioning the mobile communication apparatus of claim 6, wherein the positioning related information comprises addresses.

8. The method for positioning the mobile communication apparatus of claim 6, wherein the positioning related information received by the mobile communication apparatus is transmitted by using one of short message, voice, and graphic picture transmitting methods.

9. The method for positioning the mobile communication apparatus of claim 6, further comprising:
using the mobile communication apparatus to issue a “request for a second person's location signal” to request for a second person's positioning related information of the second person's mobile communication apparatus; and
using the mobile communication apparatus to receive the second person's positioning related information determined according to the second person's positioning signal of the second person's mobile communication apparatus.

10. The method for positioning the mobile communication apparatus of claim 9, wherein the second person's positioning related information comprises addresses.

11. The method for positioning the mobile communication apparatus of claim 9, wherein the second person's positioning related information received by the mobile communication apparatus is transmitted by using one of short message, voice, and graphic picture transmitting methods.
